(19) United States
(12) Patent Application Publication
(10) Pub. No.: US 2016/0150124 A1
(43) Pub. Date: May 26, 2016

(54) Image Forming Apparatus with User Identification Capabilities

(71) Applicant: KYOCERA Document Solutions Inc., Osaka (JP)

(72) Inventors: Debashis Panda, Concord, CA (US); Arthur Alacar, Concord, CA (US)

(21) Appl. No.: 14/551,465

(22) Filed: Nov. 24, 2014

(51) Int. Cl. H04N 1/44; G06F 3/12; H04N 1/00; G10L 15/22

(52) U.S. Cl. CPC H04N 1/442; H04N 1/4433; G10L 15/22; G06F 3/1204; G06F 3/1222; G06F 3/1238; H04N 1/00896; G10L 2015/223; H04N 2201/0094

(57) ABSTRACT

The present disclosure is directed to an image forming apparatus. The image forming apparatus may receive, from an identification unit, data indicative of a biometric characteristic of a user. The image forming apparatus may also obtain, from a storage unit, information associated with the user. The information includes user-specific information and data indicative of a stored version of the biometric characteristic of the user. The image forming apparatus may further determine that the user is registered based at least on a match between the received biometric characteristic and the stored version of the biometric characteristic. Additionally, the image forming apparatus may display a portion of the user-specific information on a display unit of an image forming apparatus.

### BACKGROUND

Unless otherwise indicated herein, the materials described in this section are not prior art to the claims in this application and are not admitted to be prior art by inclusion in this section.

An image forming apparatus may be any peripheral that produces a human-readable representation of graphics and/or text onto a physical medium. Example image forming apparatuses include printers and multifunction peripherals (MFPs). An image forming apparatus may be utilized for various tasks such as printing, scanning, and faxing, as well as many other uses.

An image forming apparatus may be connected to a network and shared by a number of users. In some cases, an image forming apparatus may require authorization by a user prior to operation in order to protect the user's privacy, personalize the image forming apparatus for that particular user, or prevent unauthorized users from operating the image forming apparatus. However, authorizing a user may be a cumbersome task and add a substantial delay when printing a document.

### SUMMARY

The present application discloses embodiments that relate to an image forming apparatus that authorizes a user based on a biometric characteristic of the user. In one aspect, the present application describes a method. The method includes receiving, from an identification unit, data indicative of a biometric characteristic of a user. The method also includes obtaining, from a storage unit, information associated with the user. The information includes user-specific information and data indicative of a stored version of the biometric characteristic of the user. The method further includes determining that the user is registered based at least on a match between the received biometric characteristic and the stored version of the biometric characteristic. In addition, the method includes displaying a portion of the user-specific information on a display unit of an image forming apparatus upon determining that the user is registered.

In another aspect, the present application describes an image forming apparatus. The image forming apparatus includes an identification unit configured to receive data indicative of a biometric characteristic of a user. The image forming apparatus also includes a storage unit configured to store information associated with the user. The information includes user-specific information and data indicative of a stored version of the biometric characteristic of the user. The image forming apparatus further includes a processing unit configured to determine that the user is registered based at least on a match between the received biometric characteristic and the stored version of the biometric characteristic.

In yet another aspect, the present disclosure describes a system. The system includes an identification unit, a display unit, a networking device, and a non-transitory computer-readable medium. The networking device is configured to provide a network connection to a storage unit over a network. The storage unit is configured to store information associated with the user. The information includes user-specific information and data indicative of a stored version of the biometric characteristic of the user. The non-transitory computer-readable medium has stored thereon instructions that, when executed by at least one processor, cause the system to perform a set of operations. The set of operations include receiving, from the identification unit, data indicative of a biometric characteristic of a user. The set of operations also includes requesting the information associated with the user. The set of operations further includes receiving the information associated with the user in response to requesting the information associated with the user. In addition, the set of operations includes determining that the user is registered based at least on a match between the received biometric characteristic and the stored version of the biometric characteristic. Further, the set of operations includes displaying a portion of the user-specific information of a display unit upon determining that the user is registered.

In another aspect, the present application describes a system. The system includes a means for receiving data indicative of a biometric characteristic of a user. The system also includes a means for obtaining information associated with the user. The information includes user-specific information and data indicative of a stored version of the biometric characteristic. The system further includes a means for determining that the user is registered based at least on a match between the received biometric characteristic and the stored version of the biometric characteristic. In addition, the system includes a means for displaying a portion of the user-specific information on a display unit of an image forming apparatus upon determining that the user is registered.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a schematic block diagram illustrating an image forming apparatus, according to an example embodiment.

FIG. 2 is a schematic block diagram illustrates an image forming apparatus, according to an example embodiment.

FIG. 3 is a flowchart illustrating a method, according to an example embodiment.

FIG. 4 is a flowchart illustrating a method, according to an example embodiment.

FIG. 5 is a flowchart illustrating a method, according to an example embodiment.

FIG. 6 is a schematic diagram illustrating example information displayed on a display unit, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments might include more or less of each element shown in a given Figure. Further, some of the illustrated elements may be combined or omitted. Yet further, an example embodiment may include elements that are not illustrated in the Figures.

### I. OVERVIEW

An example embodiment involves an image forming apparatus authenticating a user. The image forming apparatus may, for example, capture images of a user's face and use those captured images as a basis to identify and authenticate the user. Certain biometric characteristics about the user may be determined from the captured images, which the image forming apparatus may then compare to stored versions of those biometric characteristics for one or more users. If the biometric characteristics determined from the captured image match a stored version of those biometric characteristics, the user associated with the stored biometric characteristics may be authenticated by the image forming apparatus. The image forming apparatus may then proceed to display information specific to the user and may also configure the image forming apparatus with settings associated with that user.

### II. EXAMPLE SYSTEMS

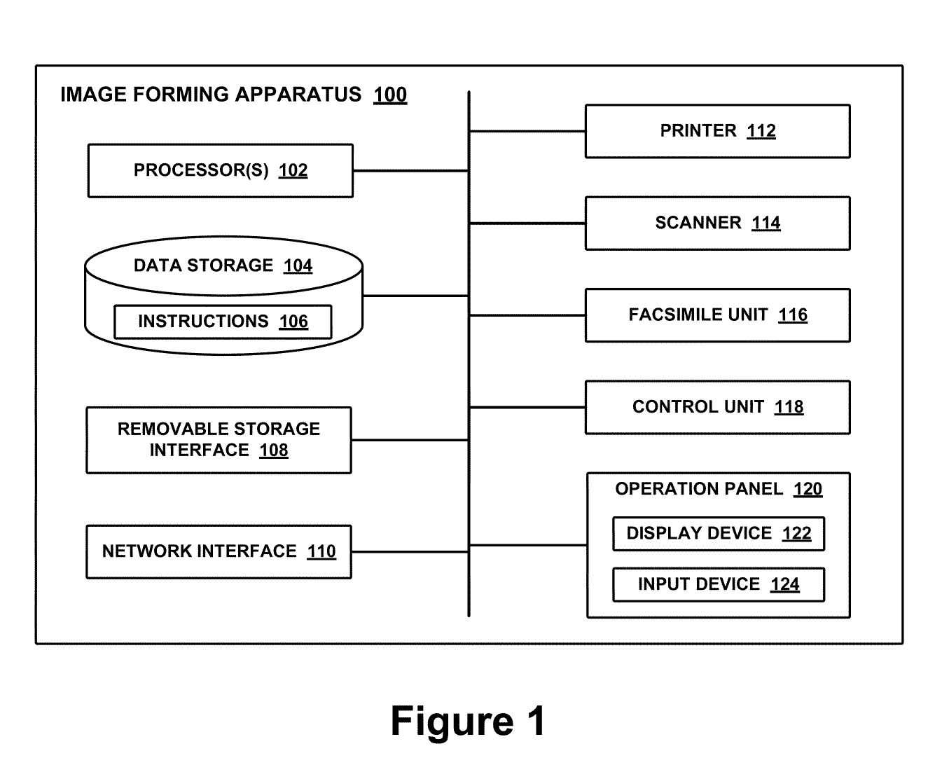

FIG. 1 is a schematic block diagram of illustrating an image forming apparatus 100, according to an example embodiment. The image forming apparatus 100 includes processor(s) 102, data storage 104 that has stored thereon instructions 106, a removable storage interface 108, a network interface 110, a printer 112, a scanner 114, a facsimile (FAX) unit 116, a control unit 118, and an operation panel 120 that includes a display device 122 and an input device 124. Each unit of image forming apparatus 100 may be connected to a bus, allowing the units to interact with each other. For example, the processor(s) 102 may request information stored on data storage 104.

The processor(s) 102 may include one or more processors capable of executing instructions, such as instructions 106, that cause the image forming apparatus 100 to perform various operations. The processor(s) 102 may include general-purpose central processing units (CPUs) and cache memory. The processor(s) 102 may also incorporate processing units for specific purposes, such as application-specific integrated circuits (ASICs) and field-programmable gate arrays (FPGAs). Other processors may also be included for executing operations particular to image forming apparatus 100.

The data storage 104 may store thereon instructions 106, which are executable by the processor(s) 102. The data storage 104 may also store information for various programs and applications, as well as data specific to the image forming apparatus 100. For example, the data storage 104 may include data for running an operating system (OS). In addition, the data storage 104 may store user data that includes various kinds of information about any number of users. The data storage 104 may include both volatile memory and non-volatile memory. Volatile memory may include random-access memory (RAM). Some examples of non-volatile memory include read-only memory (ROM), flash memory, electrically erasable programmable read only memory (EEPROM), digital tape, a hard disk drive (HDD), and a solid-state drive (SSD). The data storage 104 may include any combination of readable and/or writable volatile memories and/or non-volatile memories, along with other possible memory devices.

The removable storage interface 108 may allow for connection of external data storage, which may then be provided to the processor(s) 102 and/or the control unit 118 or copied into data storage 104. The removable storage interface 108 may include a number of connection ports, plugs, and/or slots that allow for a physical connection of an external storage device. Some example removable storage devices that may interface with image forming apparatus 100 via the removable storage interface 108 include USB flash drives, secure-digital (SD) cards (including various shaped and/or sized SD cards), compact discs (CDs), digital video discs (DVDs), and other memory cards or optical storage media.

The network interface 110 allows the image forming apparatus 100 to connect to other devices over a network. The network interface 110 may connect to a local-area network (LAN) and/or a wide-area network (WAN), such as the Internet. The network interface may include an interface for a wired connection (e.g. Ethernet) and/or wireless connection (e.g. Wi-Fi) to a network. The network interface 110 may also communicate over other wireless protocols, such as Bluetooth, radio-frequency identification (RFID), near field communication (NFC), 3G cellular communication such as CDMA, EVDO, GSM/GPRS, or 4G cellular communication, such as WiMAX or LTE, among other wireless protocols. Additionally, the network interface 110 may communicate over a telephone landline. Any combination of wired and/or wireless network interfaces and protocols may be included in network interface 110.

The printer 112 may be any device or peripheral capable of producing persistent human-readable images and/or text on a printing medium, such as paper. The printer 112 may receive print data from other units of image forming apparatus 100 representing images and/or text for printing. The printer 112 may employ a variety of technologies, such ink-based printing, toner-based printing, and thermal printing, among other technologies. An assortment of mechanical and/or electro-mechanical devices may make up the printer 112 to facilitate the transportation of printing media and the transferring of images and/or text onto the printing media. For example, the printer 112 may include trays for the storage and staging of printing media and rollers for conveying the printing media through the printer 112. The printer 112 may also include ink heads for dispensing ink onto a printing medium, photosensitive drums onto which lasers are shone to charge the drums and attract toner that is transferred onto a printing medium, and/or a thermal head for heating certain areas of a printing medium to generate images and/or text. Other devices may also be incorporated within printer 112.

The scanner 114 may be any device that can scan a document, image, or other object (which may collectively be referred to as “scanning medium” hereinafter) and produce a digital image representative of that scanning medium. The scanner 114 may emit light (e.g. via LEDs) onto the scanning medium and sense the light reflecting off the scanning medium (e.g. via a charge coupled device (CCD) line sensor or a complementary metal oxide semiconductor (CMOS) line sensor). In some implementations, the scanner 114 includes a platen glass onto which a document may be placed to be scanned. In addition, the scanner 114 may perform post-processing on the scanned image, such as rotation, compression of the data, and/or optical character recognition (OCR), among other post-processing operations.

The facsimile unit 116 may scan a document and/or images (which may be collectively referred to as “printed material” hereinafter) and transmit the scanned printed material over a telephone line (i.e. fax the scanned printed material). The facsimile unit 116 may fax the scanned printed material via the network interface 110. The facsimile unit 116 may also receive a fax transmission and communicate the received data to the printer 112 for printing. In some implementations, the facsimile unit 116 includes buttons for configuring the facsimile unit 116 and dialling a phone number and a display for displaying the status of the fax transmission, among other things.

The control unit 118 may control various electrical and/or mechanical components of the image forming apparatus 100. For example, the control unit 118 may operate one or more paper sheet feeders, conveyors, rollers, and other mechanical devices for transporting paper through the printer 112. The control unit 118 may also include device drivers that facilitate network communication, electronic displays, and the reading of information from various sensors or readers coupled to the image forming apparatus 100. In some implementations, the control unit 118 is a software application or program that interfaces the processor(s) 102 with the various units of the image forming apparatus 100.

The operation panel 120 includes a display device 122 and an input device 124 for facilitating human interaction with the image forming apparatus 100. The display device 122 may be any electronic video display, such as a liquid-crystal display (LCD). The input device 124 may include any combination of devices that allow users to input information into the operation panel 120, such as buttons, a keyboard, switches, and/or dials. In addition, the input device 124 may include a touch-screen digitizer overlaid onto the display device 122 that can sense touch and interact with the display device 112.

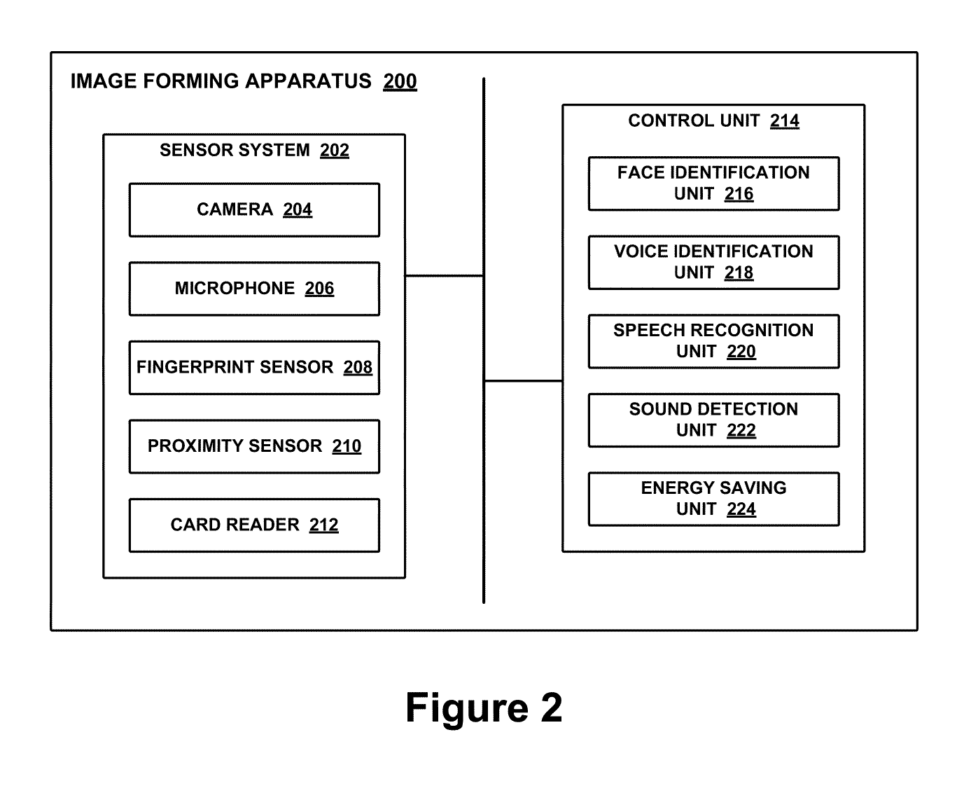

FIG. 2 is a schematic block diagram illustrating an image forming apparatus 200, according to an example embodiment. Image forming apparatus 200 may include any combination of the units of image forming apparatus 100. Additionally, image forming apparatus 200 includes a sensor system 202 and a control unit 214. Sensor system 202 may include a camera 204, a microphone 206, a fingerprint sensor 208, a proximity sensor 210, and a card reader 212. The control unit may include a face identification unit 216, a voice identification unit 218, a speech recognition unit 220, a sound detection unit 222, and an energy saving unit 224. Similarly to image forming apparatus 100, each unit of image forming apparatus 200 may be connected to a bus 226, allowing the units to interact with each other.

The camera 204 may be any image-capture device capable of recording images and/or video. The camera 204 may include a combination of hardware and software operable to produce digital images and/or video from which objects can be detected, recognized, and/or tracked. The camera 204 may interface with the face identification unit 216 to assist in facilitating facial recognition.

The microphone 206 may be any audio-capture device capable of capturing sound. The microphone 206 may include one or more transducers capable of converting sounds into electrical signals, which may then be converted into audio data. The microphone 206 may interface with the voice identification unit 218, the speech recognition unit 220, and the sound detection unit 222 to facilitate the identification of users, receive voice commands, and determine the presence of a user.

The fingerprint sensor 208 may be any device capable of scanning a human fingerprint. The fingerprint sensor 208 may identify patterns from scanned fingerprints that can be used to identify a user. The fingerprint sensor 208 may optically scan a person's finger, or may detect fingerprint ridges from capacitance changes over a scanning area. The fingerprint sensor 208 may identify one or more attributes associated with a given fingerprint, such as arch patterns, loop patterns, whorl patterns, the length of the fingerprint ridges, bifurcations in the fingerprint ridges, and the locations at which ridges end, among other attributes.

The proximity sensor 210 may be any sensor capable of detecting the presence and/or motion of objects. The proximity sensor 210 may include an infrared (IR) light source and a sensor for detecting reflections of IR light. By sensing changes in the IR light reflection, the proximity sensor 210 may determine the presence of person.

The card reader 212 may be any device capable of reading information from an identification (ID) card. The card reader 212 may include an RFID scanner and/or a magnetic strip reader, among other readers. The card reader 212 may scan information from an ID card, and image forming apparatus 200 may utilize that scanned information along with other data in order to identify and/or authenticate a user.

The face identification unit 216 may be any combination of software modules that facilitate identification of a user from captured images and/or video. The face identification unit 216 may utilize facial recognition techniques to identify and/or verify a user by comparing facial features from captured images and/or video to stored facial features of one or more registered users. In some implementations, the face identification unit 216 may recognize a user and provide an associated confidence level of that recognition.

The voice identification unit 218 may be any combination of software modules that facilitate identification of a user from recorded audio. The voice identification unit 218 may utilize speaker recognition techniques in order to identify who (if anyone) is speaking in a recorded audio segment. The voice identification unit 218 may analyze certain tonal qualities of a person's voice and compare them to stored versions of those tonal qualities to identify the speaker. Various pattern-matching and/or other machine learning techniques may also be implemented.

The speech recognition unit 220 may be any combination of software modules that facilitate recognition of vocal commands from recorded audio and execution of those vocal commands. The speech recognition unit 220 may identify one or more words spoken by a person in a recorded audio segment. The identified words may be mapped to commands, which cause the image forming apparatus 200 to execute a particular operation associated with that command. The speech recognition unit 220 may implement any machine-learning or statistical process for identifying words from a recording containing human speech.

The sound detection unit 222 may be any combination of software modules that facilitate in detection of a person's presence from captured audio. The sound detection unit 222 may analyze the amplitude of sounds around the image forming apparatus 200 and determine the presence of a person if those sounds exceed a threshold level. In some implementations, the sound detection unit 222 filters certain sounds that may occur in the absence of a person (e.g. the ringing of a phone). In alternative embodiment, the sound detection unit 222 detects vibrations such as those associated with footsteps of a person entering a room in which the image forming apparatus 200 is located. The sound detection unit 222 may, upon detecting the presence of a user, transmit a signal to the energy saving unit 224.

The energy saving unit 224 may be any combination of software and/or hardware modules that facilitate the powering up and shutting down of various units of the image forming apparatus 200 to save energy. The energy saving unit 224 may shut down one or more units of the image forming apparatus 200 after remaining idle for a predetermined length of time (i.e. enter energy-saving mode). The energy saving unit 224 may also power up one or more units of the image forming apparatus 200 in response to detecting the presence of a user (i.e. enter normal mode). The energy saving unit 224 may also power up one or more units in response to other inputs, such as receiving a print job to be executed, among other stimuli.

A “unit” as referred to herein may refer to a device, component, module, or other combination of electrical and/or mechanical elements that accomplish a particular task. In some instances, a unit may refer to a physical device that performs certain activities, such as the facsimile unit 116. In other instances, a unit may refer to a software module that executes operations for a certain purpose, such as the speech recognition unit 220. Regardless of the combination of hardware and software components that make up a unit, it should be understood that units are operable to accomplish certain tasks, and may interact with other units through hardware and/or software interfaces.

An “energy-saving” mode as referred to herein may refer to a selective powering of one or more units of an image forming apparatus. The powered-down units may be units that are not vital to the operation of an image forming apparatus and can be powered on when a user requests them for operation. In some implementations, multiple energy-saving modes may exist that allow for different amounts of energy saving. As a specific example, an energy-saving mode may shut off all units of an image forming apparatus except for the network interface 110, camera 204, and the processor(s) 102. In this example, the image forming apparatus may transition back to “normal mode” (i.e. turn on the powered-down units) in response to either receiving data via the network interface 110 or from detecting the presence of a user via the camera 204. Other energy-saving schemas may be implemented as well.

The image forming apparatus 200 may include, in addition to the units depicted in FIG. 2, one or more components of image forming apparatus 100. Image forming apparatuses referred to herein may incorporate any combination of components from image forming apparatus 100 and/or image forming apparatus 200, among other possible components. For instance, an image forming apparatus may include a power supply that converts electrical power for use by various components. It should be understood that other additional components might also be included on a particular image forming apparatus.

### III. EXAMPLE METHODS

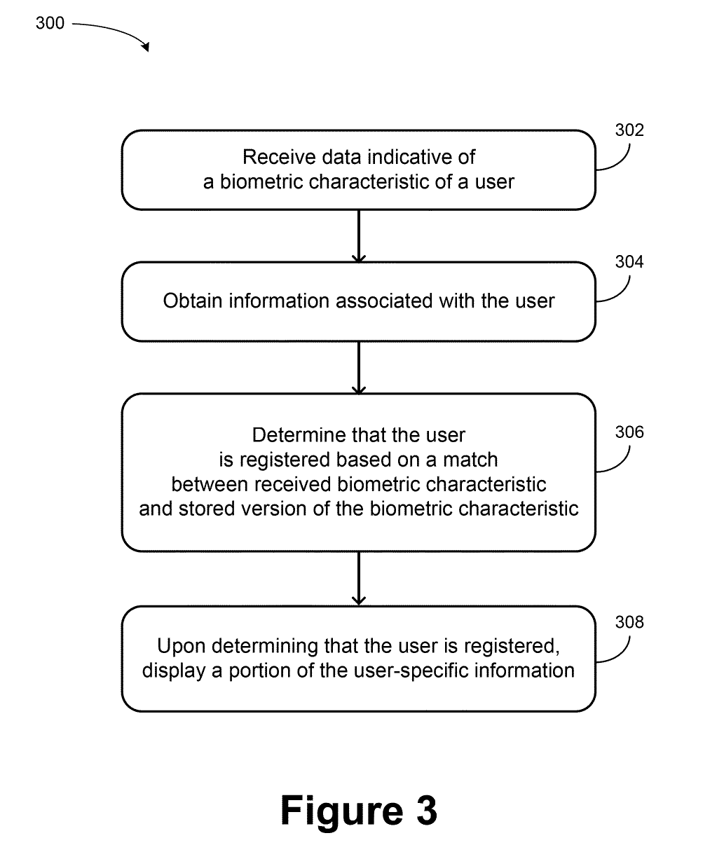

FIG. 3 is a flowchart illustrating a method 300, according to an example embodiment. More specifically, the method 300 depicts operations for determining whether a particular user is registered and displaying information specific to that user. The method 300 may be performed on image forming apparatus 100 or image forming apparatus 200, among other devices.

At step 302, the method 300 involves receiving data indicative of a biometric characteristic of a user. The biometric characteristic may include facial features identified by face identification unit 216 from images captured by camera 204, a fingerprint read in by the fingerprint sensor 208, and/or vocal qualities identified by the voice identification unit 218 from audio captured by microphone 206, or any other feature or characteristic unique to a particular user.

At step 304, the method 300 involves obtaining information associated with the user. The information associated with the user may include user-specific information and data indicative of a stored version of the biometric characteristic. The user-specific information may include a user's printing preferences, print jobs associated with a user, contacts associated with a user, and other non-printing preferences such as the user's favorite sports teams, stocks, weather, and types of news. The stored version of the biometric characteristic may be previously-recorded data of the user's biometric characteristic. For example, when a user registers with the image forming apparatus, he or she may be prompted to have his or her face photographed. The face photo may then be analyzed, and certain unique facial qualities may be identified. Data representing those unique facial qualities may be stored on data storage 104 or another data storage unit accessible over a network, which is later accessed during step 304. It should be understood that “biometric characteristic” may include a combination of biometric features of a user that uniquely identifies that user (e.g. multiple facial features, multiple fingerprint ridge patterns, and/or multiple vocal tonal qualities). A “registered” user may hereinafter refer to a user who has performed the initial registration of his or her biometric data.

As another example, a user may also register his or her voice with the image forming apparatus. During registration, the image forming apparatus may prompt the user to speak one or more words aloud, which is recorded by a microphone as an audio segment. The audio segment may be analyzed, and certain vocal qualities may be identified. Data representing those vocal qualities associated with the user may be stored on data storage 104 or another data storage unit accessible over a network, which is later accessed during step 304.

It should be understood that the biometric information associated with the users may be stored on a local data storage device, such as data storage 104, other storage devices accessible over a network, or any combination thereof.

At step 306, the method 300 involves determining that the user is registered based on a match between the received biometric characteristic and a stored version of the biometric characteristic. Determining a match may involve comparing the received characteristic to the stored version of that characteristic and determining the similarity between the two with a certain level of confidence. Such a comparison and confidence level determination may be implemented using machine-learning techniques. A “match” may hereinafter refer to a comparison between the received characteristic and the stored version of the characteristic that results in a confidence level that exceeds a threshold level of confidence. For example, a match may be determined when the comparison results in a level of confidence exceeding a 90% confidence.

As a specific example, when a user enters a field-of-view of the camera 204, the image forming apparatus may capture an image of the user's face. Image processing operations may be performed to identify facial features from the captured image (e.g. using computer vision and analysis software such as OpenCV). Example facial features that may be identified include the position, size, and/or orientation of the eyes, nose, cheekbones and/or jaw of the user in the captured image. Then, those facial features may be compared to facial features of one or more stored users. Certain machine-learning or statistical processes may be performed to facilitate this comparison. In some implementations, data of each facial feature may be compared to respective stored facial features. A confidence level proportional to the similarity between the captured facial features and the stored facial features of a user may also be determined. If this determined confidence level exceeds a threshold confidence level, the image forming apparatus may identify the user in the captured image to be the user associated with that particular set of stored facial features, thereby authenticating that user to access various operations of the image forming apparatus.

It should be understood that the operations described with respect to the facial recognition example set forth above may be applied to other biometric characteristic comparisons. Comparison of fingerprint ridges, features of a user's iris, and tonal qualities of the user's voice may also be performed in order to identify and/or verify the user. “Verifying the user” may hereinafter refer to a process that verifies the accuracy of a previous user identification (e.g. for two-factor authentication).

At step 308, the method 300 involves displaying a portion of user-specific information upon determining that the user is registered. The display device 122 may display information about the user's recent activity, contacts, pending print jobs, or incoming fax transmissions, among other information. In some implementations, the user may then command the image forming apparatus to execute pending print jobs or receive incoming fax transmissions. Additionally, the display device 112 may also display non-printing related information, such as scores of the user's favorite sports teams, weather local to the user, stocks of interest to the user, or news articles containing subject matter that the user is interested in. This information may be pulled from various data sources over, for example, the Internet, and selectively chosen based on the user-specific information.

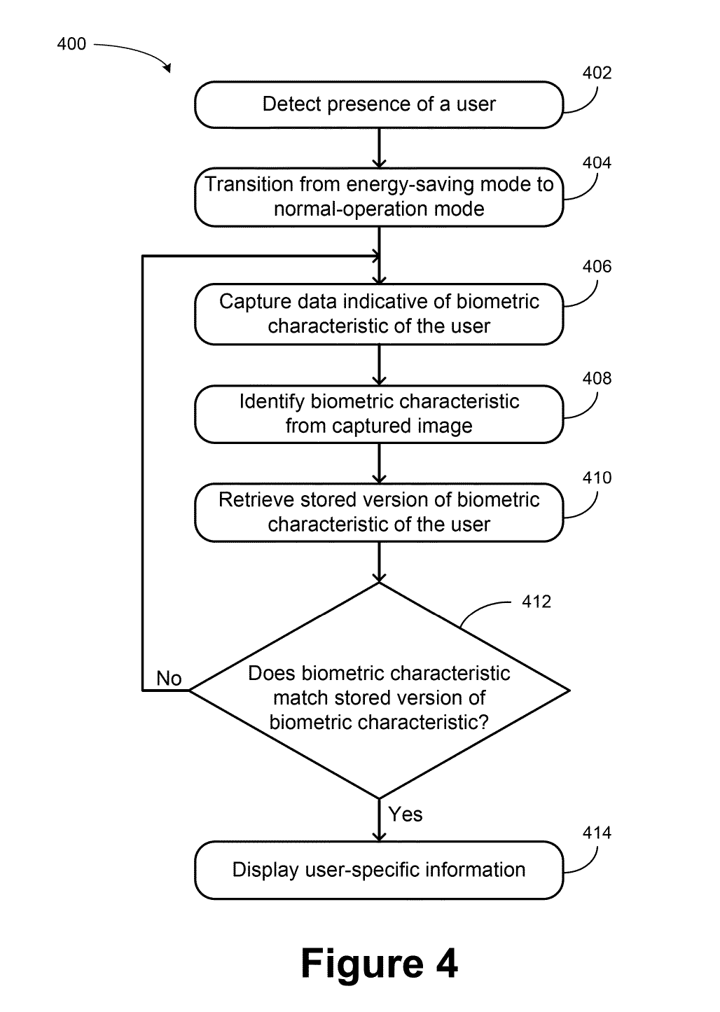

FIG. 4 is a flowchart illustrating a method 400, according to an example embodiment. More specifically, the method 400 depicts operations for transitioning from an energy-saving mode to a normal-operation mode and identifying a user from a biometric characteristic of that user. The method 400 may be performed on image forming apparatus 100 or image forming apparatus 200, among other devices.

At step 402, the method 400 involves detecting the presence of a user. In some embodiments, the image forming apparatus monitors sounds using microphone 206 and detects a user's presence upon recording a sound having an amplitude that exceeds a threshold amplitude. In other embodiments, the image forming apparatus detects movement using proximity sensor 210. In further embodiments, the camera monitors an area constituted by its field-of-view, and detects the presence of a user when a user enters within this field of view. In some implementations, the image forming apparatus may detect the presence of a user when the user enters within a portion of the camera's field-of-view (e.g. an area within the center of the field-of-view).

At step 404, the method 400 involves transitioning from an energy-saving mode to a normal-operation mode.

At step 406, the method 400 involves capturing data indicative of a biometric characteristic of a user. Step 406 may be similar to step 302 described above.

At step 408, the method 400 involves identifying a biometric characteristic of the user. Step 408 may be similar to the facial recognition operations of step 306 described above. However, other biometric characteristics or features may also be identified.

At step 410, the method 400 involves retrieving a stored version of the biometric characteristic of the user. Step 410 may be similar to step 304 described above.

At step 412, the method 400 involves determining whether the biometric characteristic matches the stored version of the biometric characteristic. Step 412 may be similar to step 306 described above. If the biometric characteristic does not match the stored version of the biometric characteristic, the method 400 returns to step 406 to repeat steps 406, 408, and 410 to repeat the authentication process. On the other hand, if the biometric characteristic matches the stored version of the biometric characteristic, the method 400 proceeds to step 414. Determining that the biometric characteristic matches the stored version of the biometric characteristic may include determining a confidence level from the comparison, and determining whether that confidence level exceeds a threshold confidence level. For example, if the comparison produces a 70% confidence level that the user is “User A,” but the threshold confidence level to determine a match is 90%, then the method 400 returns to step 406. However, if the comparison produces a 95% confidence level that the user is “User A,” the confidence level is determined to exceed the 90% threshold level, and the method 400 proceeds to step 414 for displaying information specific to “User A.”

Note that a confidence level is associated with each individual comparison. The confidence level is proportional to the similarity between a received biometric characteristic and a stored version of the biometric characteristic. For example, if an image of the user's face is captured, and the received image is very similar to a stored image of the face of “User A,” the confidence level will be high (e.g. 95%). Alternatively, if the received image is very different from the stored image of the face of “User A,” the confidence level will be low (e.g. 40%).

The image forming apparatus may determine a match between a received biometric characteristic and a stored version of the biometric characteristic if the confidence level of the comparison exceeds a threshold confidence level. For example, a “strict” setting might only allow a user to be authenticated if a 95% or greater confidence level is produced during authentication. As another example, an “approximate” setting might allow a user to be authenticated if an 80% or greater confidence level is produced during authentication. In other words, the threshold confidence level required to determine a “match” may be set on the image forming apparatus.

Upon returning to step 406, the method 400 repeats steps 406-412. The method 400 may involve repeating steps 406-412 once, twice, or any predetermined number of times. If the predetermined number of consecutive authentication attempts fail, the image forming apparatus may stop executing method 400.

In some implementations, after the predetermined number of authentication attempts fail, the image forming apparatus may request to capture a different biometric characteristic from the user. For example, if authentication of the user through facial recognition is unsuccessful, the image forming apparatus may request to capture the user's fingerprint or record the user's voice. The user's fingerprint or recorded audio segment of the user's voice might be used to authenticate the user thereafter.

If the authentication using certain biometric information (e.g. using facial recognition) is unsuccessful, the user may select an alternative biometric characteristic to be read by the image forming apparatus for authentication. The user may select his or her desired alternative biometric characteristic to be read using, for example, the operation panel 120. In another embodiment, the user may speak audio commands (e.g. “try fingerprint”) to select a different biometric characteristic to be read by the image forming apparatus for authentication.

At step 414, the method 400 involves displaying user-specific information. Step 414 may be similar to step 308 described above.

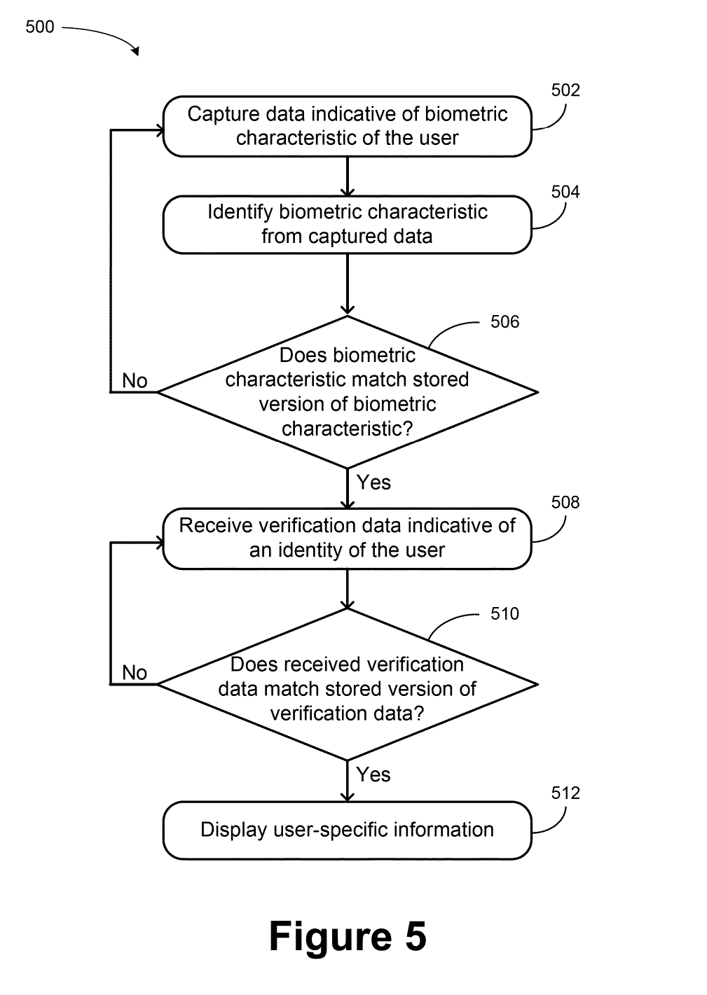

FIG. 5 is a flowchart illustrating a method 500, according to an example embodiment. More specifically, the method 500 depicts an example method utilizing two-factor authentication of a user. The method 500 may be performed on image forming apparatus 100 or image forming apparatus 200, among other devices.

At step 502, the method 500 involves capturing data indicative of a biometric characteristic of the user. Step 502 may be similar to step 406 and step 302 as describe above.

At step 504, the method 500 involves identifying a biometric characteristic from the captured data. Step 504 may be similar to step 408 or portions of step 306 as describe above.

At step 506, the method 500 involves determining whether the biometric characteristic matches a stored version of the biometric characteristic. Step 506 may be similar to step 412 and step 306 as described above. If no match is found, the method 500 returns to step 502. Alternatively, if a match is found, the method 500 proceeds to step 508. For the purposes of explanation, the user identified in method 500 is “User A.”

At step 508, the method 500 involves receiving verification data indicative of an identity of the user. Verification data may include the user's password, a key code set by the user, a pattern drawn by the user on a touch screen, or data read in by the card reader 212 of an ID card, among other types of verification data. A user may input a password, key code, or pattern at operation panel 120. In some embodiments, the verification data may also be data representative of a different biometric characteristic of the user.

At step 510, the method 500 involves determining whether the verification data matches the stored version of the verification data. The comparison and matching of step 510 may be similar to the matching as describe above. However, unlike the identification of a user as previously described, the comparison and matching at step 510 need only be performed with respect to a particular user—specifically, the user identified at step 508 (“User A,” for the purposes of this explanation). Thus, at step 510, the method 500 may involve retrieving a stored version of the verification data from a data storage (such as data storage 104) for “User A” and performing the comparison on that retrieved verification data. As a result, the verification step does not require comparing the verification data to stored versions for multiple users (although, it may be desired to do so in various embodiments).

In some cases, a match of the verification data may require a perfect similarity to the stored version of the verification data, such as when the verification data is a password, key code, or data read in from an ID card. In other cases, a match of the verification data may require a comparison that produces a confidence level exceeding a threshold level, such when the verification data is another biometric characteristic or a drawn pattern. If the verification data does not match the stored version, the method 500 returns to step 508. Alternatively, if the verification data matches the stored version, the user has been identified and verified (i.e. two-factor authenticated), and the method 500 proceeds to step 512.

At step 512, the method 500 involves displaying user-specific information. Step 512 may be similar to step 414 and step 308 as previously described.

It should be understood that the operations of methods 300, 400, and 500 may be executed in a different order than is shown in FIGS. 3, 4, and 5. In certain implementations, one or more operations of methods 300, 400, and 500 may be performed in parallel on one or more processors. Any combination of operations from methods 300, 400, and 500 may be executed on image forming apparatus 100 and/or image forming apparatus 200.

### IV. EXAMPLE IMPLEMENTATIONS

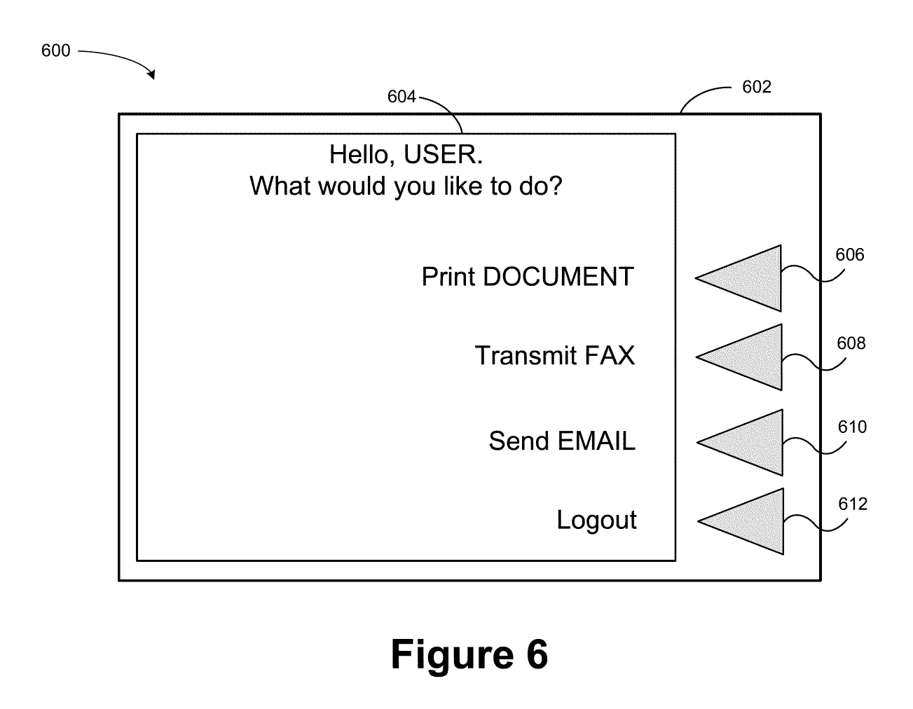

FIG. 6 illustrates example information 600 displayed on a display unit 604, according to an example embodiment. The information may be displayed on a display unit 604 (which may be similar to display unit 122) of operation panel 602 (which may be similar to operation panel 120). In addition, buttons 606, 608, 610, and 612 (which collectively may be similar to input device 124) may also be present. It should be understood that the illustrated operation panel in FIG. 6 is merely an example shown for explanatory purposes. Other operation panel configurations and information may also be displayed. For example, buttons 606, 608, 610, and 612 may instead be implemented as “soft” buttons displayed on a touch-sensitive display unit.

The content on the display unit 604 may be displayed as a result of authenticating “USER.” In this example, certain user-specific information may be displayed that is relevant to the user. For instance, the image forming apparatus may prompt USER to print DOCUMENT, transmit FAX, send EMAIL, or logout of the image forming apparatus. Other example operations may be prompted to USER depending on the user's recent activity and/or preferences.

If the user presses button 606, the image forming apparatus may print DOCUMENT. In some instances, DOCUMENT may have been requested to be printed from a different computing device or terminal apparatus, but is prevented from being printed until the user is authenticated at the printer and presses button 606. This may be desired if, for example, DOCUMENT contains sensitive information and the image forming apparatus is not located nearby USER. In other instances, the DOCUMENT may have been recently uploaded to a document server or cloud-based document storage, which is then detected by the image forming apparatus and causes it to prompt the user to print the recently-uploaded document. In yet another instance, the image forming apparatus receives a fax transmission directed to USER, but awaits the authentication of the user and for the user to press button 606 before printing out the received fax transmission.

If the user presses button 608, the image forming apparatus may transmit FAX. In some instances, USER may have previously scanned a document for transmission, and pressing button 608 initiates the transmission of that FAX to a previously-entered phone number. In other instances, USER has not previously scanned a document, and pressing button 608 initiates a process to scan a document, input a phone number, and transmit the facsimile.

If the user presses button 610, the image forming apparatus may send EMAIL. Certain prewritten emails may be produced automatically and sent to contacts associated with USER for various reasons. For example, if USER recently transmitted a fax to one of the USER's contacts, pressing button 610 may send an email to that contact to notify them of the recent fax transmission. In another example scenario, USER may press button 610, and the display device 604 may allow for USER to input an email at the image forming apparatus and send it to one of USER's contacts. For instance, it may be desired for a user to scan a document and send it directly to a USER's contact in one step. Such an operation may begin by pressing button 610.

If the user presses button 612, the image forming apparatus may log USER out of the image forming apparatus. It may be desired for a user to log out, so as to prevent another from operating the image forming apparatus as USER, although USER is no longer using the image forming apparatus.

It should be understood that the examples described with respect to FIG. 6 are merely example operations. Other operations may also be performed without departing from the scope of this application.

### V. VARIATIONS

In some embodiments, the image forming apparatus is configured to register multiple versions of biometric information for a particular user. When determining whether that particular user is registered, the image forming apparatus may compare a received biometric characteristic to one or more of the stored versions of the biometric characteristics for that particular user. By comparing the received biometric characteristic to multiple stored version of that biometric characteristic, authentication and/or verification of the user may be performed more accurately and under a variety of environmental conditions.

During registration, the image forming apparatus might capture a number of images of a user's face under different conditions (e.g. varying distances from the camera, different angles of the user's face, varying lighting conditions, and different facial expressions, among other conditions) using the camera and store them onto a data storage device. When authenticating and/or verifying that particular user, the image forming apparatus may capture an image of the user's face and compare the captured image to one or more of the stored images of that user's face under the different conditions. For example, if the image forming apparatus determines that a stored image matches the received image of the user's face, the authentication process completes, and the image forming apparatus proceeds to displaying user-specific information.

As another example, the image forming apparatus may capture a number of audio segments of the user's voice under varying conditions (e.g. varying volumes, with different background noise, and varying pitches of the user's voice, among other conditions) during registration using the microphone and store them onto a data storage device. When authenticating and/or verifying that particular user, the image forming apparatus may capture a recording of the user's voice and compare the captured recording to one or more of the stored audio segments of the user's voice. For example, if the image forming apparatus determines that a stored audio segment matches the captured recording, the authentication process completes, and the image forming apparatus proceeds to displaying user-specific information.

In some embodiments, the image forming apparatus includes a speaker that can produce sound. The speaker may be utilized to notify the user of certain information, or to provide audible feedback in response to executing various operations. As one example, at step 308, step 414, and step 512, the user-specific information that is provided to the user may also be spoken aloud to the user. For instance, the image forming apparatus may audibly inform the user of weather, stocks, sports scores, and/or news articles of interest. This may be accomplished by pulling the information from various sources and converting the text information into an audio signal using text-to-speech techniques.

In some embodiments, the image forming apparatus may capture audio that includes a user's speech. The speech recognition unit 220 may identify one or more words from the captured audio. In some cases, the identified words may be representative of particular auditory cues or commands. In response to receiving such auditory cues or commands, the image forming apparatus may perform operations associated with those cues or commands.

For instance, an auditory cue may “wake up” the image forming apparatus. In one embodiment, the image forming apparatus may respond to a particular auditory cue, such as “wake up” or “turn on,” by activating one or more units of the image forming apparatus to bring it from an energy-saving state to a normal state. The auditory cue may also be a non-verbal sound produced by a user or a certain device. As one example, the user may clap a number of times to activate the image forming apparatus in an energy-saving state. As another example, the user may use a device to produce a particular auditory sound, which may or may not be audible to the human ear, to activate the image forming apparatus.

The auditory cues may also be used to initiate a listening mode of the image forming apparatus. In response to the image forming apparatus detecting an auditory cue, it may begin listening for vocal commands from a user. For example, an auditory cue of “printer” may then cause the image forming apparatus to begin listening for other commands, such as “start fax.” As another example, the user may command the image forming apparatus by saying “send email,” and then proceeding to dictate a series of words to be sent in an email to a user's contact. Any of the operations described within this application may be initiated via vocal commands received at the image forming apparatus 100.

In some embodiments, it may be desired to prevent execution of a particular operation. For example, a user may wish to transmit a fax at a certain time in the future, but will not be nearby the image forming apparatus at that time to execute that fax transmission. Under such circumstances, the image forming apparatus may allow the user to scan the documents, but prevent the transmission of the fax until a specified time.

In various embodiments, the image forming apparatus may predict various operations that the user may wish to execute. For example, a user may upload a document to a document server that is monitored by the image forming apparatus. After authenticating the user, the image forming apparatus may prompt the user to print the recently-uploaded document. As another example, a user may have recently received an email containing document attachments, and the image forming apparatus may prompt the user to print those recently-received attachments. Other predictive printing determinations may also be made.

In certain embodiments, the image forming apparatus may, upon scanning a document, automatically upload the scanned document to a document server or cloud-based document storage service. Such an automatic upload may be performed if the user has authorized this in the user's preferences. The image forming apparatus may also perform a one-step scan and emailing of the scanned document to the user's email inbox.

In some embodiments, the confirmation received in response to transmitting a fax may be converted to digital data and automatically stored onto a document server or sent to the recipient user's email inbox. Such automatic confirmation emailing or storage may be performed if the user has authorized this in the user's preferences.

In some implementations, the camera 204 may be attached to a motorized mount (e.g. a gimbal) that may be operable to change the direction to which the camera is pointing. Users may vary in height, and it may be desired to allow the camera to point directly at the user's face to allow for more accurate facial recognition. In addition, requiring that a user stand or sit at a particular location may be cumbersome and inefficient. Thus, the image forming apparatus may perform real-time or near real-time image recognition techniques to track the user and the user's face and cause the camera 204 to rotate to point at the user's face.

In some implementations, the microphone 204 may also be attached to a motorized mount (e.g. a gimbal) that may be operable to change the direction in which the microphone is pointing. The voice identification unit 218 and/or the speech recognition unit 220 might determine the location of the user and point the microphone 204 at the user. In addition, the voice identification unit 218 and/or the speech recognition unit 220 might receive information from the face identification unit 216 about the user's location and operate the microphone to track the user. In certain implementations, the microphone may be a directional microphone to avoid picking up ambient sounds, and pointing the microphone 204 in the direction of the user might allow for a clearer recording of the user's voice and thus more accurate voice identification and speech recognition.

In some cases, it may be desired to assist a maintenance person or another individual servicing the image forming apparatus by providing that person with information about the progress of the maintenance. For example, certain ink or toner may be low, and the image forming apparatus may provide via the display device 122 information about which ink or toner is low. As another example, paper may be stuck at a certain location within the printer 112, and the image forming apparatus may display information to assist a person servicing the image forming apparatus that indicates the location of the paper jam. Other maintenance-assisting information may also be displayed on display device 122 to aid in the servicing of the image forming apparatus.

### VI. CONCLUSION

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

1. A method comprising:
receiving, from an identification unit, data indicative of a biometric characteristic of a user;
obtaining, from a storage unit, information associated with the user, wherein the information includes user-specific information and data indicative of a stored version of the biometric characteristic of the user;
determining that the user is registered based at least on a match between the received biometric characteristic and the stored version of the biometric characteristic; and
upon determining that the user is registered, displaying a portion of the user-specific information on a display unit of an image forming apparatus, wherein the user-specific information includes user profile information related to the user's operation of the image forming apparatus after determining that the user is registered.

2. The method of claim 1, wherein determining that the user is registered based at least on a match between the received biometric characteristic and the stored version of the biometric characteristic comprises:
comparing the data indicative of the received biometric characteristic to the data indicative of the stored version of the biometric characteristic obtained from the storage unit;
determining a confidence level indicating an estimated accuracy of the comparison; and
determining that the received biometric characteristic matches the stored version of the biometric characteristic based on the determined confidence level exceeding a threshold confidence level.

3. The method of claim 1, further comprising:
in response to determining that the user is registered, transitioning from an energy-saving state to a normal-operation state.

4. The method of claim 1, further comprising:
detecting a sound having an amplitude exceeding a threshold amplitude and responsively transitioning from an energy-saving state to a normal-operation state.

5. The method of claim 1, wherein the storage unit further includes a stored version of an auditory cue, and wherein the method further comprises:
receiving an auditory cue and responsively transitioning from an energy-saving state to a normal-operation state based on determining that the received auditory cue matches the stored version of the auditory cue.

6. The method of claim 1, wherein the user-specific information further includes a user setting indicative of a configuration of the image forming apparatus associated with the user, and wherein the method further comprises:
in response to determining that the user is registered, configuring the image forming apparatus based on the user setting.

7. The method of claim 1, further comprising:
receiving a print request associated with the user, wherein the print request includes at least one print job;
in response to determining that the user is registered, printing at least one document based on the at least one print job.

8. The method of claim 1, wherein the biometric characteristic is a first biometric characteristic, wherein the user-specific information further includes data indicative of a stored version of a second biometric characteristic of the user, and wherein the method further comprises:
receiving data indicative of the second biometric characteristic of the user; and
verifying that the user is registered based on a match between the received second biometric characteristic of the user and the stored version of the second biometric characteristic.

9. An image forming apparatus comprising:
an identification unit configured to receive data indicative of a biometric characteristic of a user;
a storage unit configured to store information associated with the user, wherein the information includes user-specific information and data indicative of a stored version of the biometric characteristic of the user;
a processing unit configured to determine that the user is registered based at least on a match between the received biometric characteristic and the stored version of the biometric characteristic; and
a display unit configured to display a portion of the user-specific information upon determining that the user is registered, wherein the user-specific information includes user profile information related to the user's operation of the image forming apparatus after determining that the user is registered.

10. The image forming apparatus of claim 9, wherein the identification unit includes an image-capture device, and wherein receiving the biometric characteristic of the user comprises:
detecting that a particular portion of the user has entered into a predetermined detection area;
upon detecting that the particular portion of the user has entered into the predetermined detection area, capturing an image of the particular portion of the user; and
identifying the biometric characteristic of the user based on the captured image.

11. The image forming apparatus of claim 9, further comprising:
a voice recognition unit configured to (i) receive vocal input and (ii) identify the biometric characteristic of the user based on the vocal input.

12. The image forming apparatus of claim 9, wherein the storage unit is further configured to store a version of a vocal command, and wherein the image forming apparatus further comprises:
a speech recognition unit configured to receive vocal input and responsively transmit instructions to control a portion of the image forming apparatus based on determining that the received vocal input matches the stored version of the vocal command.

13. The image forming apparatus of claim 12, wherein the portion of the user-specific information is a first portion, and wherein the display unit is further configured to display a second portion of the user-specific information in response to the speech recognition unit determining that the received vocal input matches the stored version of the vocal command.

14. The image forming apparatus of claim 9, wherein the identification unit is a first identification unit, wherein the biometric characteristic is a first biometric characteristic, and wherein the image forming apparatus further comprises:
a second identification unit configured to receive a second biometric characteristic of the user,
wherein the processing unit is further configured to verify that the user is registered based on a match between the received second biometric characteristic of the user and the stored version of the second biometric characteristic.

15. The image forming apparatus of claim 14, wherein the second identification unit includes a fingerprint recognition device, and wherein detecting the second biometric characteristic comprises:
recording data representative of at least one attribute of a particular portion of the user; and
identifying the biometric characteristic of the user based on the recorded data.

16. The image forming apparatus of claim 9, wherein the identification unit is a first identification unit, wherein the user-specific information includes authentication data associated with the user, and wherein the image forming apparatus further comprises:
a second identification unit configured to receive input data from an identification device indicative of an identity of the user,
wherein the processing unit is further configured to verify that the user is registered based on a match between the received input and the authentication data associated with the user.

17. A system comprising:
an identification unit;
a display unit;
a networking device configured to provide a network connection to a storage unit over a network, wherein the storage unit is configured to store information associated with the user, wherein the information includes user-specific information and data indicative of a stored version of the biometric characteristic of the user; and
a non-transitory computer-readable medium having stored thereon instructions that, when executed by at least one processor, cause the system to perform a set of operations comprising:
receiving, from the identification unit, data indicative of a biometric characteristic of a user;
requesting the information associated with the user;
receiving the information associated with the user in response to requesting the information associated with the user;
determining that the user is registered based at least on a match between the received biometric characteristic and the stored version of the biometric characteristic; and
upon determining that the user is registered, displaying a portion of the user-specific information on a display unit, wherein the user-specific information includes user profile information related to the user's operation of the image forming apparatus after determining that the user is registered.

18. (canceled)

19. (canceled)

20. (canceled)

21. The method of claim 1, wherein the user profile information includes one or more of information on recent activity of the user, contacts, at least one pending print job, and at least one incoming fax transmission.

22. The method of claim 1, further comprising:
uploading a document to a document server, wherein the image forming apparatus is configured to monitor the document server; and
upon determining that the user is registered, prompting the user to print the uploaded document.

23. The method of claim 1, further comprising:
receiving, at the image forming apparatus, a document as an attachment in an electronic mail message;
upon determining that the user is registered, prompting the user to print the document received as the attachment in the electronic mail message.
